(19) United States
(12) Patent Application Publication
(10) Pub. No.: US 2017/0331770 A1
(43) Pub. Date: Nov. 16, 2017

(54) PRESENCE INDICATOR SYSTEM

(71) Applicant: Cisco Technology, Inc., San Jose, CA (US)

(72) Inventors: Keith GRIFFIN, Oranmore (IE); Andrew HENDERSON, Spiddal (IE); Candice LAVENDER, Dunmore (IE)

(21) Appl. No.: 15/150,454

(22) Filed: May 10, 2016

(51) Int. Cl. H04L 12/58; H04L 29/06; G06F 3/0484; G06F 3/0481

(52) U.S. Cl. CPC H04L 51/043; H04L 65/403; G06F 3/0481; G06F 3/0484; H04L 65/1069

(57) ABSTRACT

In one embodiment, a method includes receiving data including presence data for at least one collaboration contact from a collaboration server, receiving input data from at least one input device, preparing a user interface screen for output to a display device, the user interface screen including a future presence indicator including a graphical representation disposed at least one of, around or on, at least part of an avatar of the at least one collaboration contact, the graphical representation including a plurality of sections from a circular shape, each one section of the plurality of sections having a border including a circular arc, indicating a future availability status of the at least one collaboration contact based on the presence data for the at least one collaboration contact, having an angular dimension being indicative of a time period represented by the one section.

### TECHNICAL FIELD

The present disclosure generally relates to presence indication in collaboration systems.

### BACKGROUND

Collaboration systems typically provide a single presence indicator per collaboration contact. For example, collaboration clients may show presence as a singular visual indicator, e.g. a green presence pill, if the contact is available or an orange pill, if in the contact is in a meeting. Some collaboration systems may also show when a contact is next free, for example, “Available—free until 3 pm” or “Currently busy—free at 4 pm”.

### BRIEF DESCRIPTION OF THE DRAWINGS

The present disclosure will be understood and appreciated more fully from the following detailed description, taken in conjunction with the drawings in which:

FIG. 1 is a partly pictorial, partly block diagram view of a user interface screen system constructed and operative in accordance with an embodiment of the present disclosure;

FIG. 2-3 are views of a user interface screen showing current and future availability for a collaboration contact in the system of FIG. 1;

FIG. 4 is a view of an alternative user interface screen showing current and future availability for a collaboration contact in the system of FIG. 1;

FIGS. 5-7 are views of a user interface screen showing a plurality of communication-mode-specific presence indicators per collaboration contact for use in the user interface screen system of FIG. 1;

FIG. 8 is a view of an alternative user interface screen showing a plurality of communication-mode-specific presence indicators per collaboration contact for use in the user interface screen system of FIG. 1;

FIG. 9 is a view of a user interface screen showing current and future availability for a collaboration contact and a plurality of communication-mode-specific presence indicators for that collaboration contact for use in the system of FIG. 1;

FIGS. 10-12 are views of a group presence indicator for a plurality of collaboration contacts for use in the system of FIG. 1; and

FIG. 13 is a view of a group presence indicator and a future availability indicator for a plurality of collaboration contacts for use in the system of FIG. 1.

### DESCRIPTION OF EXAMPLE EMBODIMENTS

### Overview

There is provided in accordance with an embodiment of the present disclosure, a method including receiving data including presence data for at least one collaboration contact from a collaboration server, receiving input data from at least one input device, preparing a user interface screen for output to a display device, the user interface screen including a future presence indicator including a graphical representation disposed at least one of, around or on, at least part of an avatar of the at least one collaboration contact, the graphical representation including a plurality of sections from a circular shape, each one section of the plurality of sections having a border including a circular arc, indicating a future availability status of the at least one collaboration contact based on the presence data for the at least one collaboration contact, having an angular dimension being indicative of a time period represented by the one section, receiving the input data from the user input interface, interpreting the input data to include establishing a collaboration session with the at least one collaboration contact, establishing the collaboration session with the at least one collaboration contact, the input data also including collaboration data, and sending the collaboration data to at least one device associated with the at least one collaboration contact.

### DETAILED DESCRIPTION

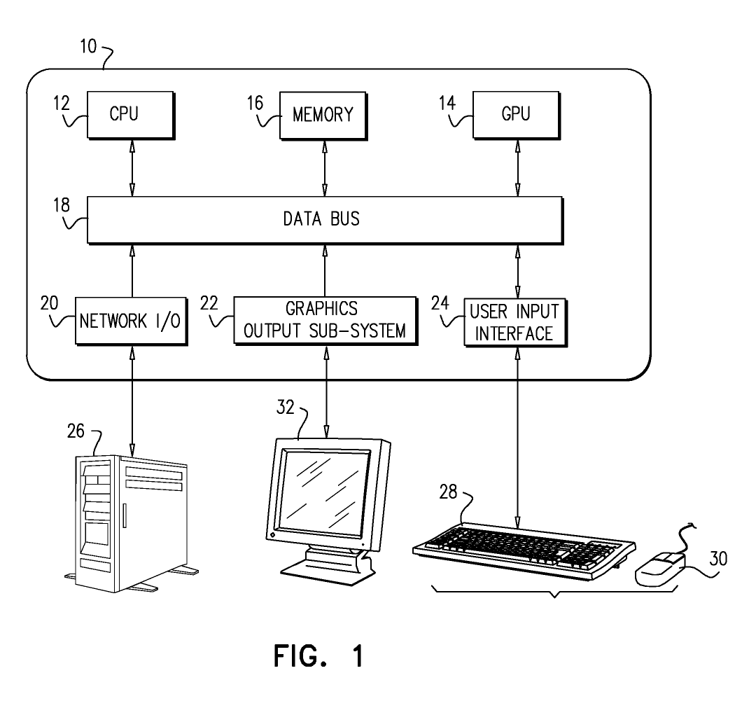

Reference is now made to FIG. 1, which is a partly pictorial, partly block diagram view of a user interface screen system 10 constructed and operative in accordance with an embodiment of the present disclosure. The user interface screen system 10 includes a central processing unit (CPU) 12, a graphics processing unit (GPU) 14, a memory 16, a data bus 18, a network input/output interface 20, a graphics output sub-system 22 and a user input interface 24.

The memory 16 is operative to store data used by the central processing unit 12 and the graphics processing unit 14. The data bus 18 is operative to transfer data between the various elements of the user interface screen system 10. The network input/output interface 20 is operative to receive data including presence data for one or more collaboration contacts from a collaboration server 26. The presence data may include data about when one or more collaboration contacts are free or busy from the current time to a certain time in the future (for example, but not limited to, the next 24 hours). The network input/output interface 20 may be a wired and/or wireless network interface.

The user input interface 24 is operative to receive input data from at least one input device, for example, but not limited to, a keyboard 28, a mouse 30 and/or a touchscreen, a microphone, a camera. The input data may indicate a screen position (e.g., a screen position of a cursor or a finger or a stylus) and/or a mouse click or an equivalent selection command and/or keyboard input, by way of example only. The input data may include collaboration data such as instant message (IM) data and/or audio data and/or video data. When the user interface screen system 10 is implemented in a smart phone, the user input interface 24 may receive the input data from a touchscreen, microphone and/or camera of the smart phone.

The central processing unit 12 is operative to prepare a user interface screen for output to a display device 32. The graphics processing unit 14, may also perform graphics processing of the user interface screen including customizing the user interface screen according to specifications of the display device 32. The graphics output sub-system 22 is operative to output the user interface screen to the display device 32. The display device 32 may be implemented as a stand-alone monitor as shown in FIG. 1, as a display integrated with the user interface screen system 10 typically incorporating a touchscreen (for example, when the user interface screen system 10 is implemented in a smart phone), or as a projector and screen arrangement, by way of example only. The graphics processing unit 14 may be implemented in the central processing unit 12.

The central processing unit 12 is also operative to receive the input data from the user input interface 24 and interpret the input data, for example, based on a screen position (e.g., a screen position of a cursor or a finger or a stylus), to include establishing a collaboration session with one or more collaboration contacts (e.g., collaboration with a single contact or collaboration with a group of contacts). The central processing unit 12 is also operative to establish a collaboration session with the collaboration contact(s). The network input/output interface 20 is operative to send the collaboration data, via the collaboration server 26, to the device(s) associated with the collaboration contact(s) (i.e., to a device of a collaboration contact in one-to-one collaboration or to the devices of the respective collaboration contacts in group collaboration).

It will be appreciated that the above described functions of the central processing unit 12 may be implemented using a suitably coded software application running on the central processing unit 12.

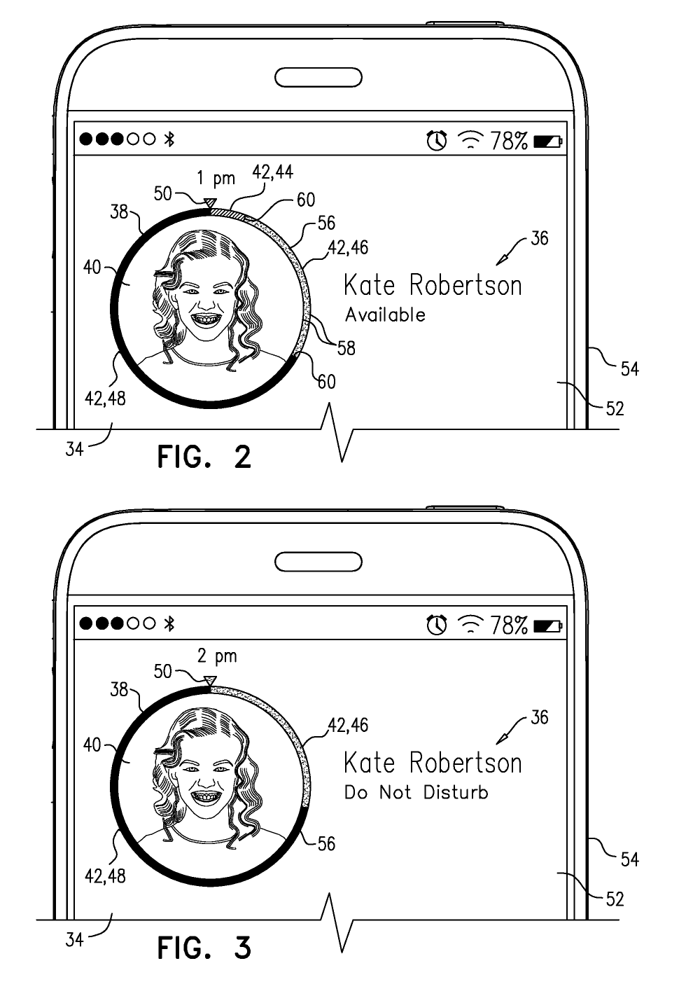

Reference is now made to FIG. 2-3, which are views of a user interface screen 34 showing current and future availability for a collaboration contact 36 in the system 10 of FIG. 1. The user interface screen 34 shows current and future availability of the collaboration contact 36 using an annular ring 38 around an avatar image 40 of the collaboration contact 36. The annular ring 38 may be broken down into different sections 42 which may be colored and/or shaded and/or patterned according to an availability status of the collaboration contact 36. The top of the annular ring 38 corresponds to the current time. Proceeding around the annular ring 38 in a clockwise fashion corresponds to subsequent future times, further around the annular ring 38 corresponding to more distant times from the current time.

In the example of FIG. 2, the current time of 1 pm is indicated at the top of the annular ring 38. Additionally, or alternatively a triangle 50 or any other suitable shape may be disposed at the top of the annular ring 38 to indicate the current time. The triangle 50 may also indicate the current availability of the collaboration contact 36 using a suitable color and/or shading and/or pattern. A first section 44 of the annular ring 38 is shown with a pattern (which could be additionally or alternatively a shading and/or color, e.g., the color green) indicating that the contact is available between now and the next hour (2 pm). A second section 46 of the annular ring 38 is shown with a different pattern (which could be additionally or alternatively a shading and/or color, e.g., the color red) indicating that the contact is busy between 2 pm and 5 pm. A third section 48 of the annular ring 38 is shown with a different pattern (which could be additionally or alternatively a shading and/or color, e.g., the color gray) indicating a time period outside office hours when the contact will be offline after 5 pm.

The annular ring 38 may be compared to a clock face, so as time passes the annular ring 38 rotates anti-clockwise and past presence data is removed and additional future presence data is added to the annular ring 38. The network input/output interface 20 (FIG. 1) is operative to receive presence data updates. In response to the presence data updates, the CPU 12 (FIG. 1) is operative to update the annular ring 38. The time period represented by the annular ring 38 may be configurable, e.g., the ring could show the next 60 minutes or the next 12 hours, etc. The annular ring 38 may even include one or more toggle buttons (not shown) to toggle between viewing the next 60 minutes or next 12 hours, by way of example only. In FIGS. 2-3, Kate's presence is shown at 1 pm (FIG. 2) and then at one hour later, at 2 pm (FIG. 3). In the examples of FIGS. 2-3 the annular ring 38 represents 12 hours and turns anti-clockwise 30 (360/12) degrees every hour. The angular dimension of each section 42 is a function of the time period represented by that section, for example, 6 degrees per minute (for an annular ring 38 representing 60 minutes) or 30 degrees per hour (for an annular ring 38 representing 12 hours).

The availability status may be based on calendar meeting data and/or other collaboration data, for example, but not limited to, current phone calls, current video calls and/or current IM interactions. For example, if calendar data and other collaboration data indicates that a contact is free, the availability status may be set to “available”. If the calendar data indicates the contact is free, but collaboration data indicates that the contact is on an online meeting, then the availability status may be set to “busy”. The ‘busy’ state could then show until next appointment. Alternatively, the central processing unit 12 (FIG. 1) could estimate how long a call will last, based on average length of phone calls in general or with this contact in particular. So if average calls last 30 min, then the ‘busy state’ could be shown to last for the next 30 minutes. If the person is still on a call after 25 min, then the ‘busy’ state could move out a further 10 or 15 minutes, by way of example only.

The user interface screen 34 of FIGS. 2-3 is shown as being displayed on a screen 52 of a mobile phone 54. It will be appreciated that the user interface screen 34 may be prepared by any suitable processing device for display on a suitable display device as described above with reference to FIG. 1.

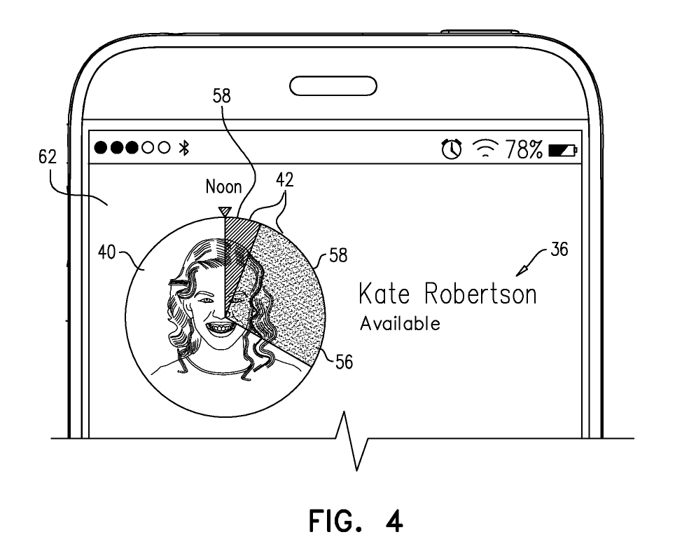

Preparation of the user interface screen 34 of FIGS. 2-3 is now described in more detail with reference to the user interface screen system 10 of FIG. 1. The central processing unit 12 (optionally in conjunction with the graphics processing unit 14) is operative to prepare the user interface screen 34 for output to the display device 32. The user interface screen 34 includes a future presence indicator 56 including a graphical representation disposed around and/or on, at least part of the avatar image 40 of the collaboration contact 36. The future presence indicator 56 of FIG. 2-3 is disposed around all of the avatar image 40 whereas the future presence indicator 56 of FIG. 4 is disposed on part of the avatar image 40. The graphical representation includes the sections 42 from a circular shape. In FIGS. 2-3, the sections 42 are from an annular ring and each section 42 has a border including two circular arc borders 58 and two straight line borders 60 where each section 42 is disposed around the avatar image 40. The circular arcs 58 and the straight line borders 60 are only labeled on one of the sections 42 for the sake of simplicity.

Each section 42 has an angular dimension indicative of a time period represented by that section 42. The central processing unit 12 is operative to calculate the angular dimension of the time period represented by the section 42 as 6 degrees per minute (when the whole annular ring 38 represents 60 minutes) or 30 degrees per hour (when the whole annular ring 38 represents 12 hours). The highest point of the graphical representation, indicated by the triangle 50, corresponds to the current time.

The future availability status may be selected from a plurality of different future availability statuses, for example, but not limited to, available, away, busy, presenting, in a meeting, on a call and offline. Each section 42 indicates the future availability status of the collaboration contact 36 based on the presence data for the collaboration contact 36 using a presentation type in that section 42. Each future availability status has a different presentation type including at least one of the following: a color; a shading; or a pattern, for example, but not limited to, green for “available”, red for “busy” and orange for “away”. The future presence indicator 56 may also be used as a group presence indicator for a plurality of collaboration contacts described in more detail with reference to FIG. 13.

The user interface screen 34 increases the efficiency and speed of a system running the user interface screen 34, as the users do not need to enter a different screen or even a different application to determine future availability of collaboration contacts. The increase in efficiency may happen whether the user interface screen 34 is generated in a client device or in a cloud server, by way of example only.

Reference is again made to FIG. 4, which is a view of an alternative user interface screen 62 showing current and future availability for the collaboration contact 36 in the system 10 of FIG. 1. The user interface screen 62 is substantially the same as the user interface screen 34 of FIG. 2-3 except for the following differences. The sections 42 of the future presence indicator 56 are from a circle and each section 42 is a circular section (like a slice from a pie chart). Each section 42 is disposed, typically superimposed, over part of the avatar image 40. Each section 42 includes one circular arc 58.

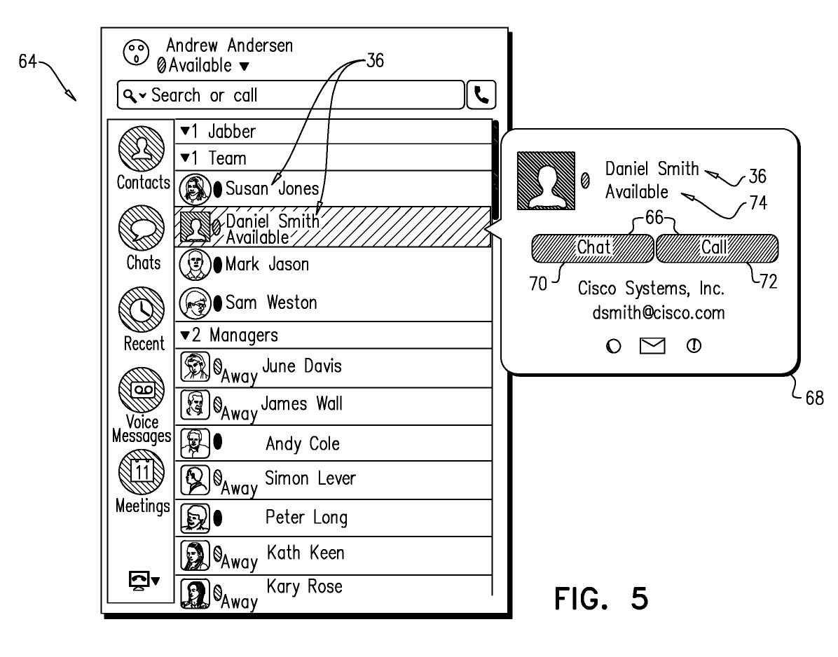

Reference is now made to FIGS. 5-7, which are views of a user interface screen 64 showing a plurality of communication-mode-specific presence indicators 66 per collaboration contact 36 for use in the user interface screen system 10 of FIG. 1. Hovering over any of the collaboration contacts 36 (only two are labeled for the sake of simplicity), results in a contact card 68 being displayed for the hovered over collaboration contact 36. The contact card 68 includes a general availability status 74 and communication-mode-specific presence indicators 66 showing availability of the selected collaboration contact 36 to communicate via different communication modes.

In the example of FIG. 5, a chat activation button 70 and a call activation button 72 show that the selected collaboration contact 36 is available to receive both chat (IM) and calls (video and/or audio). The communication-mode-specific presence indicators 66 are disposed on the activation buttons 70, 72. However, it will be appreciated that the communication-mode-specific presence indicators 66 may be disposed on the contact card 68 adjacent to the activation buttons 70, 72. The contact card 68 of FIG. 5 includes a general availability status 74 shown as “Available”.

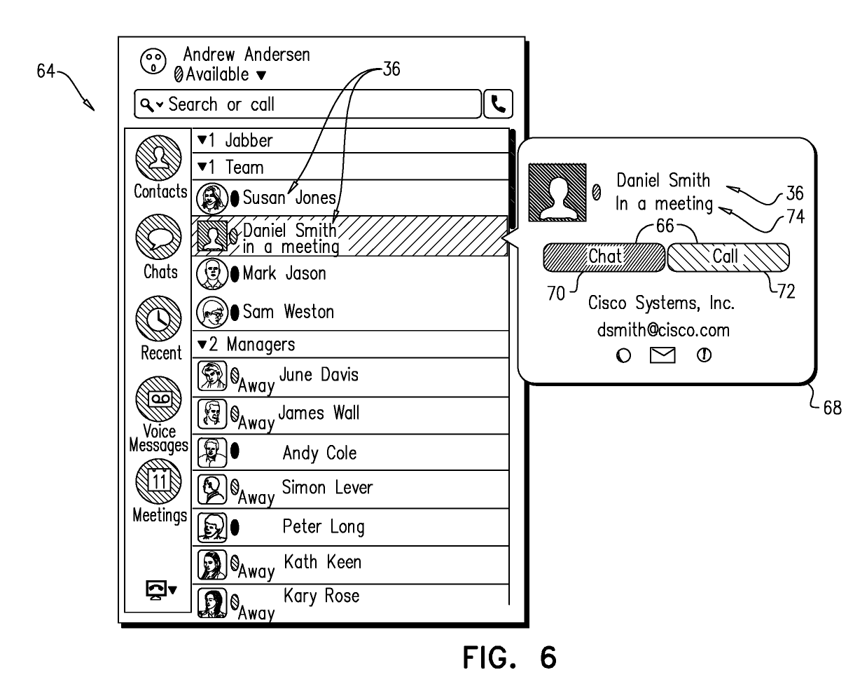

In the example of FIG. 6, the chat activation button 70 shows that the collaboration contact 36 is available to receive chat (IM). The call activation button 72 shows that the collaboration contact 36 is in a meeting and therefore is not available to receive calls (video and/or audio). The contact card 68 of FIG. 6 includes a general availability status 74 shown as “In a meeting”. The logic of how the communication-mode-specific presence indicators 66 are set based on presence data (indicated by the general availability status 74) may be fixed by a system administrator or it may be user configurable. For example, if the general availability status 74 is “in a meeting”, the collaboration contact 36 may set the chat activation button 70 to show that the collaboration contact 36 is in a meeting and therefore unavailable or available as shown in FIG. 6. The logic may depend on many factors, for example, if the collaboration contact 36 is in a meeting, the chat activation button 70 may show that the collaboration contact 36 is available for chat. However, if in addition to being in a meeting the collaboration contact 36 is also on one chat conversation, then the chat activation button 70 may show that the collaboration contact 36 is unavailable for chat, by way of example only. If the chat activation button 70 and/or the call activation button 72 indicate(s) that the collaboration contact 36 is “busy” or “do not disturb” or “presenting”, by way of example, the chat activation button 70 and/or the call activation button 72, respectively, may also inhibit the associated collaboration button, e.g., chat or call (voice and/or video) It will be appreciated that the logic may be depend on various factors and may be configured according to user and/or system requirements.

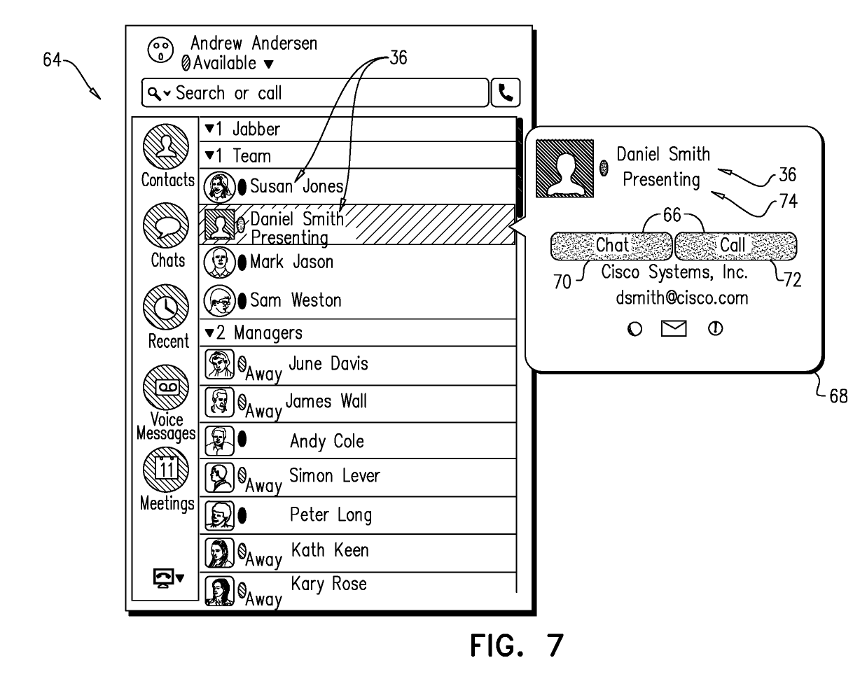

In the example of FIG. 7, the chat activation button 70 and the call activation button 72 show that the selected collaboration contact 36 has a “do not disturb” status for receiving both chat (IM) and calls (video and/or audio). The contact card 68 of FIG. 5 includes a general availability status 74 shown as “Presenting”.

The user interface screen 64 of FIGS. 5-7 is now described in more detail with reference to the user interface screen system 10 of FIG. 1. The central processing unit 12 (optionally in conjunction with the graphics processing unit 14) is operative to prepare the user interface screen 64 for output to the display device 32. The user interface screen 64 includes the communication-mode-specific presence indicators 66 for the collaboration contact 36. The communication-mode-specific presence indicators 66 indicate a communication-mode-specific availability status (e.g., available, away, do not disturb, busy, offline) of the collaboration contact 36 for a plurality of different communication modes (selected from two or more of the following: a telephone call mode; an instant message mode; and a video call mode, by way of example only) based on the presence data (e.g., from calendar data and/or other collaboration software data) for the collaboration contact 36. The communication-mode-specific presence indicators 66 included in the user interface screen 64 for the collaboration contact 36 show that the collaboration contact 36 has a first communication-mode-specific availability status (e.g., available, away, do not disturb, busy, offline) for a communication mode (e.g., Chat (IM)) and a second communication-mode-specific availability status (e.g., available, away, do not disturb, busy, offline) for a different communication mode (e.g. phone or video call). The number of communication-mode-specific presence indicators 66 per collaboration contact 36 is not limited to two, but may be greater than two, depending on the number of available communication modes.

The communication-mode-specific presence indicators 66 indicate different communication-mode-specific availability statuses using a presentation type selected from different presentation types. The different communication-mode-specific availability statuses have different presentation types including at least one of the following: a color; a shading; or a pattern, to differentiate the different communication-mode-specific availability statuses from each other.

Each communication-mode-specific presence indicator 66 for the collaboration contact 36 may be disposed on the activation button 70, 72 for activating the communication mode for which that communication-mode-specific presence indicator 66 is indicating the communication-mode-specific availability status of the collaboration contact 36.

The user interface screen 64 increases the efficiency, speed and bandwidth of a system running the user interface screen 64, as the users do not need to unnecessarily initiate a collaboration session based on guessing whether the collaboration contact 36 will be available or not.

Reference is now made to FIG. 8, which is a view of an alternative user interface screen 82 showing a plurality of communication-mode-specific presence indicators 84 per collaboration contact 36 for use in the user interface screen system 10 of FIG. 1. In FIG. 8, the communication-mode-specific presence indicators 84 are shown without needing to slide out a contact card.

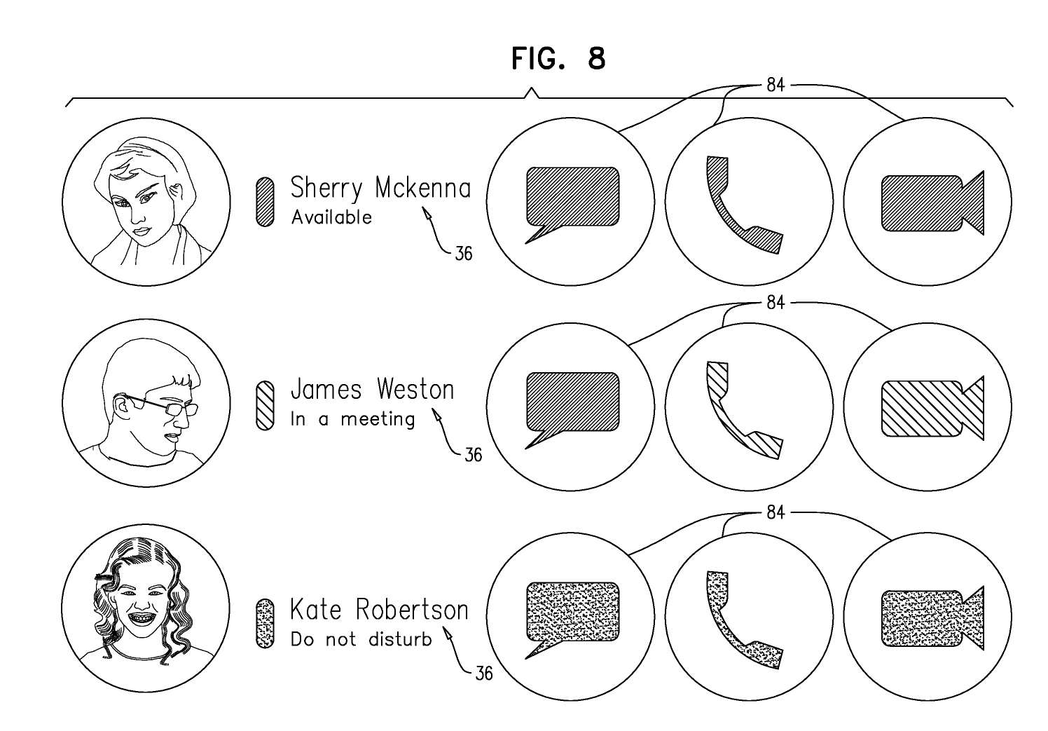

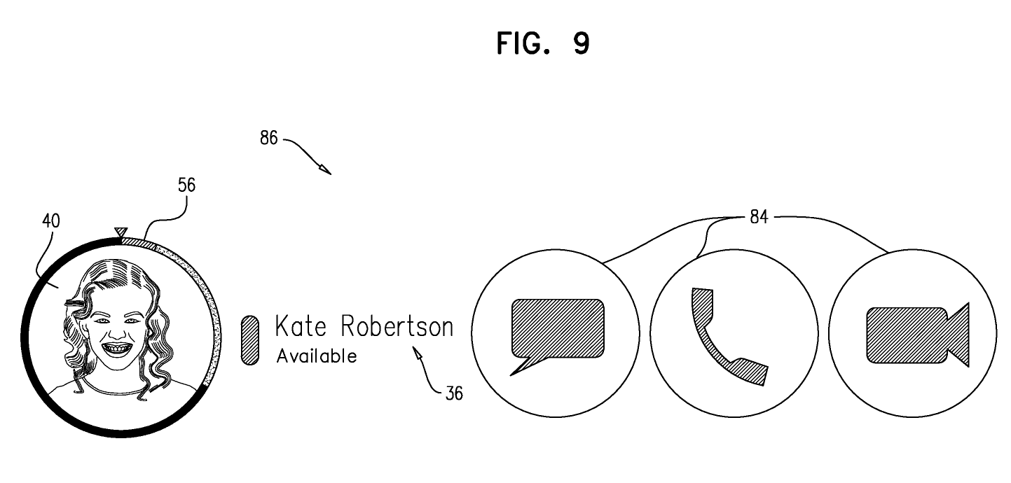

Reference is now made to FIG. 9, which is a view of a user interface screen 86 showing current and future availability for the collaboration contact 36 and the communication-mode-specific presence indicators 84 for that collaboration contact 36 for use in the system 10 of FIG. 1. The user interface screen 86 combines the future presence indicator 56 of FIG. 2 which is disposed around the avatar image 40 of the collaboration contact 36 and the communication-mode-specific presence indicators 84 of FIG. 8. The central processing unit 12 (FIG. 1) (optionally in conjunction with the graphics processing unit 14 (FIG. 1)) is operative to prepare the user interface screen 86 including: the future presence indicator 56 including a graphical representation disposed around and/or on, at least part of the avatar image 40 of the collaboration contact 36; and the communication-mode-specific presence indicators 84 for the collaboration contact 36. It will be appreciated that the future presence indicator 56 of FIG. 2 may also be combined with the communication-mode-specific presence indicators 66 of FIGS. 5-7. It will be appreciated that the future presence indicator 56 of FIG. 4 may also be combined with the communication-mode-specific presence indicators 66 of FIGS. 5-7 or the communication-mode-specific presence indicators 84 of FIG. 8.

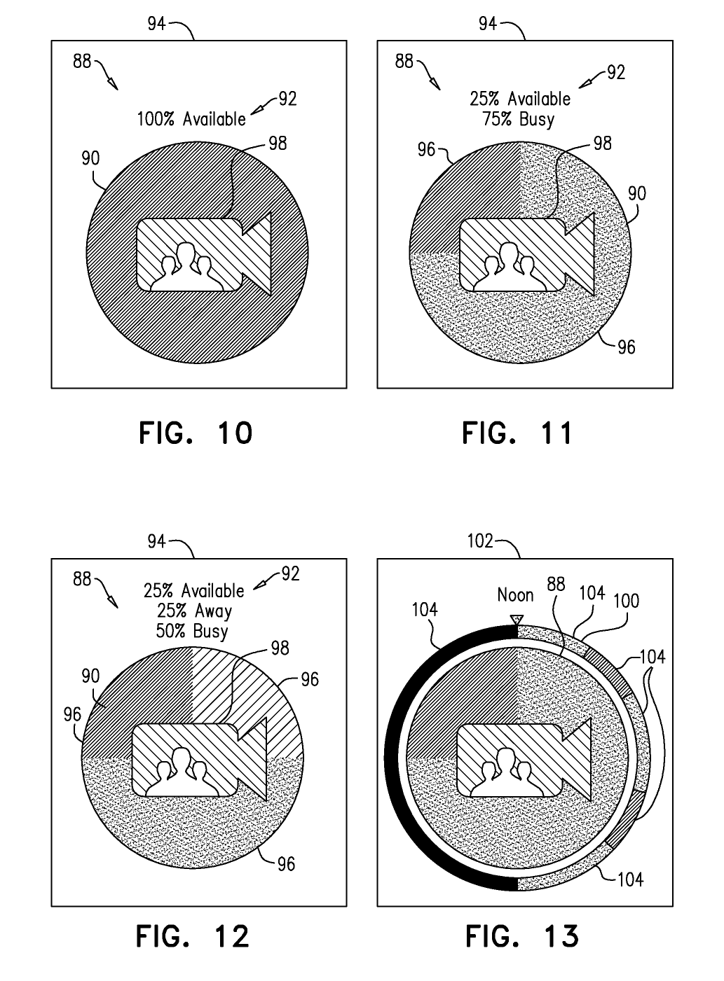

Reference is now made to FIGS. 10-12, which are views of a group presence indicator 88 for a group of collaboration contacts for use in the system 10 of FIG. 1. In multiparty communications, the group presence indicator 88 shows the percentage availability of the collaboration contacts using a graphical representation 90 and/or a textual indicator 92. Depending on available screen space, an optional drill down may be possible to show individual collaboration contact's availability by hovering over the graphical representation 90 and/or the textual indicator 92. Clicking on the graphical representation 90 (or using another suitable selection method) may result in bringing all available group members into a group communication. In the example of FIGS. 10-11, the communication type is video. However, it will be appreciated that any suitable communication type may be used, for example, but not limited to, chat (IM) or voice.

The central processing unit 12 (FIG. 1) (optionally in conjunction with the graphics processing unit 14 (FIG. 1)) is operative to prepare a user interface screen 94 for output to the display device 32 (FIG. 1). The user interface screen 94 includes the group presence indicator 88 for the collaboration contacts. The group presence indicator 88 indicates, based on the presence data for the plurality of collaboration contacts: (a) a single group availability status when each of the collaboration contacts has the same availability status as shown in FIG. 10; and (b) different group availability statuses when different sub-groups of the collaboration contacts have different group availability statuses as shown in FIGS. 11-12. An amount (percentage or head count) of the collaboration contacts in each of the different sub-groups is indicated by the group presence indicator 88. The group presence indicator 88 may include the graphical representation 90 and/or the textual indicator 92 listing the amount of collaboration contacts in the different sub-groups.

When different sub-groups of the collaboration contacts have different group availability statuses, the graphical representation 90 may include a plurality of sections 96. The different group availability statuses may be selected from the following: away; available; do not disturb; busy; and offline. Each section 96 has a different presentation type corresponding to a different group availability status. The different presentation types may include at least one of the following: a color; a shading; or a pattern to differentiate one presentation type from another presentation type. The sections 96 of the graphical representation 90 may be arranged as a pie chart (as shown in FIGS. 10-12) or a donut chart. An angular dimension of each section 96 corresponds to the amount of collaboration contacts in the sub-group indicated by that section 96.

The group presence indicator 88 for the collaboration contacts may be disposed around and/or on an activation button 98 for activating the collaboration session with the plurality of collaboration contacts. The collaboration session may be implemented using any suitable communication mode for example, but not limited to, chat (IM), voice and/or video.

The user interface screen 94 increases the efficiency, speed and bandwidth of a system running the user interface screen 94 as the users do not need to unnecessarily to initiate a group collaboration session based on guessing whether the different group collaboration contacts will be available or not.

Reference is now made to FIG. 13, which is a view of the group presence indicator 88 and a future availability indicator 100 for a plurality of collaboration contacts for use in the system of FIG. 1. The central processing unit 12 (FIG. 1) (optionally in conjunction with the graphics processing unit 14 (FIG. 1) is operative to prepare a user interface screen 102 including the group presence indicator 88 and the future availability indicator 100. The future availability indicator 100 is substantially the same as the future presence indicator 56 of FIGS. 2-3 except that the future availability indicator 100 indicates the future availability of the plurality of collaboration contacts as a group. The future availability indicator 100 typically includes different sections 104. Each section 104 may indicate an availability status of the group during the time period covered by that section 104. The future availability status of the group during any time period may be calculated based on majority status of the group members, by way of example only. Alternatively, if any of the contacts are not available during a time period, then the status may be set to “Busy” and only if all the contacts are available during a time period is the status set to “Available”. Alternatively, the status for a time period may be determined by a majority calculation which is weighted according to how many contacts have each status and giving higher weight to some contact(s). It will be appreciated that many alternative algorithms for determining group availability are possible.

There is also provided in accordance with another embodiment of the present disclosure a system including a network input/output interface to receive data including presence data for a collaboration contact from a collaboration server, a user input interface to receive input data from at least one input device, a central processing unit to prepare a user interface screen for output to a display device, the user interface screen including a plurality of communication-mode-specific presence indicators for the collaboration contact, the plurality of communication-mode-specific presence indicators indicating a communication-mode-specific availability status of the collaboration contact for a plurality of different communication modes based on the presence data for the collaboration contact, receive the input data from the user input interface, interpret the input data to include establishing a collaboration session with the collaboration contact, and establish the collaboration session with the collaboration contact, the input data also including collaboration data, wherein the network input/output interface is operative to send the collaboration data to a device associated with the collaboration contact.

Further in accordance with an embodiment of the present disclosure the plurality of communication-mode-specific presence indicators included in the user interface screen for the collaboration contact show that the collaboration contact has a first communication-mode-specific availability status for a first communication mode of the plurality of different communication modes and a second communication-mode-specific availability status for a second communication mode of the plurality of different communication modes, the first communication-mode-specific availability status being different from the second communication-mode-specific availability status at the same time.

Still further in accordance with an embodiment of the present disclosure the plurality of communication-mode-specific presence indicators indicate different communication-mode-specific availability statuses using a presentation type selected from a plurality of different presentation types, each one of the different communication-mode-specific availability statuses having a different presentation type including at least one of the following a color, a shading, or a pattern.

Additionally in accordance with an embodiment of the present disclosure each one communication-mode-specific presence indicator of the plurality of communication-mode-specific presence indicators for the collaboration contact is disposed on an activation button for activating one of the plurality of different communication modes for which the one communication-mode-specific presence indicator is indicating the communication-mode-specific availability status of the collaboration contact.

Moreover in accordance with an embodiment of the present disclosure the communication-mode-specific availability status is selected from the following away, available, do not disturb, busy, and offline.

Further in accordance with an embodiment of the present disclosure the plurality of different communication modes include at least two of the following a telephone call mode, an instant message mode, and a video call mode.

There is also provided in accordance with still another embodiment of the present disclosure a system including a network input/output interface to receive data including presence data for a plurality of collaboration contacts from a collaboration server, a user input interface to receive input data from at least one input device, a central processing unit to prepare a user interface screen for output to a display device, the user interface screen including a group presence indicator for the plurality of collaboration contacts, the group presence indicator indicating, based on the presence data for the plurality of collaboration contacts a single group availability status when each one of the plurality of collaboration contacts has a same availability status, and a plurality of different group availability statuses when different sub-groups of the plurality of collaboration contacts have different group availability statuses, an amount of the plurality of collaboration contacts in each of the different sub-groups being indicated by the group presence indicator, receive the input data from the user input interface, interpret the input data to include establishing a collaboration session with the plurality of collaboration contacts, and establish the collaboration session with the plurality of collaboration contacts, the input data also including collaboration data, wherein the network input/output interface is operative to send the collaboration data to a plurality of devices associated with the plurality of collaboration contacts.

Still further in accordance with an embodiment of the present disclosure the group presence indicator includes a graphical representation, and when the different sub-groups of the plurality of collaboration contacts have the different group availability statuses, the graphical representation may include a plurality of sections, each one section of the plurality of sections having a different presentation type corresponding to a different one of the different group availability statuses, an angular dimension of each one section of the plurality of sections corresponding to the amount of the plurality of collaboration contacts in one of the different sub-groups indicated by the one section.

Additionally in accordance with an embodiment of the present disclosure the plurality of sections of the graphical representation are arranged as a pie chart or donut chart.

Moreover in accordance with an embodiment of the present disclosure the different presentation type includes at least one of the following a color, a shading, or a pattern.

Further in accordance with an embodiment of the present disclosure the group presence indicator for the plurality of collaboration contacts is disposed at least one of, around or on, an activation button for activating the collaboration session with the plurality of collaboration contacts.

Still further in accordance with an embodiment of the present disclosure the different group availability statuses are selected from the following away, available, do not disturb, busy, and offline.

In practice, some or all of these functions may be combined in a single physical component or, alternatively, implemented using multiple physical components. These physical components may comprise hard-wired or programmable devices, or a combination of the two. In some embodiments, at least some of the functions of the processing circuitry may be carried out by a programmable processor under the control of suitable software. This software may be downloaded to a device in electronic form, over a network, for example. Alternatively or additionally, the software may be stored in tangible, non-transitory computer-readable storage media, such as optical, magnetic, or electronic memory.

It is appreciated that software components may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the present disclosure.

It will be appreciated that various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

It will be appreciated by persons skilled in the art that the present disclosure is not limited by what has been particularly shown and described hereinabove. Rather the scope of the disclosure is defined by the appended claims and equivalents thereof.

What is claimed is:

1. A method comprising:
receiving data including presence data for at least one collaboration contact from a collaboration server;
receiving input data from at least one input device;
preparing a user interface screen for output to a display device, the user interface screen including a future presence indicator including a graphical representation disposed at least one of, around or on, at least part of an avatar of the at least one collaboration contact, the graphical representation including a plurality of sections from a circular shape, each one section of the plurality of sections: having a border including a circular arc; indicating a future availability status of the at least one collaboration contact based on the presence data for the at least one collaboration contact; having an angular dimension being indicative of a time period represented by the one section;
receiving the input data from the user input interface;
interpreting the input data to include establishing a collaboration session with the at least one collaboration contact;
establishing the collaboration session with the at least one collaboration contact, the input data also including collaboration data; and
sending the collaboration data to at least one device associated with the at least one collaboration contact.

2. The method according to claim 1, wherein the plurality of sections are from a circle and each one section of the plurality of sections is a circular section, each one section of the plurality of sections being disposed over the at least part of the avatar.

3. The method according to claim 1, wherein the plurality of sections are from an annular ring and each one section of the plurality of sections includes two straight line borders and two circular arc borders, each one section of the plurality of sections being disposed around the at least part of the avatar.

4. The method according to claim 1, wherein each one section of the plurality of sections indicates the future availability status of the at least one collaboration contact using a presentation type in the one section, the future availability status being selected from a plurality of different future availability statuses, each one of the different future availability statuses having a different presentation type including at least one of the following: a color; a shading; or a pattern.

5. The method according to claim 1, wherein a highest point of the graphical representation corresponds to a current time.

6. The method according to claim 1, further comprising calculating the angular dimension of the time period represented by the one section as 6 degrees per minute or 30 degrees per hour.

7. The method according to claim 1, further comprising preparing the user interface screen including a plurality of communication-mode-specific presence indicators for the at least one collaboration contact, the plurality of communication-mode-specific presence indicators indicating a communication-mode-specific availability status of the at least one collaboration contact for a plurality of different communication modes based on the presence data for the at least one collaboration contact.

8. The method according to claim 7, wherein the plurality of communication-mode-specific presence indicators included in the user interface screen for the at least one collaboration contact show that the at least one collaboration contact has a first communication-mode-specific availability status for a first communication mode of the plurality of different communication modes and a second communication-mode-specific availability status for a second communication mode of the plurality of different communication modes, the first communication-mode-specific availability status being different from the second communication-mode-specific availability status at the same time.

9. The method according to claim 1, wherein the at least one collaboration contact is a plurality of collaboration contacts, the method further comprising preparing the user interface screen including a group presence indicator for the plurality of collaboration contacts, the group presence indicator indicating, based on the presence data for the plurality of collaboration contacts:
a single group availability status when each one of the plurality of collaboration contacts has a same availability status; and
a plurality of different group availability statuses when different sub-groups of the plurality of collaboration contacts have different group availability statuses, an amount of the plurality of collaboration contacts in each of the different sub-groups being indicated by the group presence indicator.

10. The method according to claim 9, wherein:
the group presence indicator includes a graphical representation; and
when the different sub-groups of the plurality of collaboration contacts have the different group availability statuses, the graphical representation may include a plurality of sections, each one section of the plurality of sections having a different presentation type corresponding to a different one of the different group availability statuses, an angular dimension of each one section of the plurality of sections corresponding to the amount of the plurality of collaboration contacts in one of the different sub-groups indicated by the one section.

11. A system comprising:
a network input/output interface to receive data including presence data for at least one collaboration contact from a collaboration server;
a user input interface to receive input data from at least one input device;
a central processing unit to:
prepare a user interface screen for output to a display device, the user interface screen including a future presence indicator including a graphical representation disposed at least one of, around or on, at least part of an avatar of the at least one collaboration contact, the graphical representation including a plurality of sections from a circular shape, each one section of the plurality of sections: having a border including a circular arc; indicating a future availability status of the at least one collaboration contact based on the presence data for the at least one collaboration contact; having an angular dimension being indicative of a time period represented by the one section;
receive the input data from the user input interface;
interpret the input data to include establishing a collaboration session with the at least one collaboration contact; and
establish the collaboration session with the at least one collaboration contact, the input data also including collaboration data, wherein the network input/output interface is operative to send the collaboration data to at least one device associated with the at least one collaboration contact.

12. The system according to claim 11, wherein the plurality of sections are from a circle and each one section of the plurality of sections is a circular section, each one section of the plurality of sections being disposed over the at least part of the avatar.

13. The system according to claim 11, wherein the plurality of sections are from an annular ring and each one section of the plurality of sections includes two straight line borders and two circular arc borders, each one section of the plurality of sections being disposed around the at least part of the avatar.

14. The system according to claim 11, wherein each one section of the plurality of sections indicates the future availability status of the at least one collaboration contact using a presentation type in the one section, the future availability status being selected from a plurality of different future availability statuses, each one of the different future availability statuses having a different presentation type including at least one of the following: a color; a shading; or a pattern.

15. The system according to claim 11, wherein a highest point of the graphical representation corresponds to a current time.

16. The system according to claim 11, wherein the central processing unit is operative to calculate the angular dimension of the time period represented by the one section as 6 degrees per minute or 30 degrees per hour.

17. The system according to claim 11, wherein the central processing unit is operative to prepare the user interface screen including a plurality of communication-mode-specific presence indicators for the at least one collaboration contact, the plurality of communication-mode-specific presence indicators indicating a communication-mode-specific availability status of the at least one collaboration contact for a plurality of different communication modes based on the presence data for the at least one collaboration contact.

18. The system according to claim 17, wherein the plurality of communication-mode-specific presence indicators included in the user interface screen for the at least one collaboration contact show that the at least one collaboration contact has a first communication-mode-specific availability status for a first communication mode of the plurality of different communication modes and a second communication-mode-specific availability status for a second communication mode of the plurality of different communication modes, the first communication-mode-specific availability status being different from the second communication-mode-specific availability status at the same time.

19. The system according to claim 11, wherein the at least one collaboration contact is a plurality of collaboration contacts, the central processing unit is operative to prepare the user interface screen including a group presence indicator for the plurality of collaboration contacts, the group presence indicator indicating, based on the presence data for the plurality of collaboration contacts:
a single group availability status when each one of the plurality of collaboration contacts has a same availability status; and
a plurality of different group availability statuses when different sub-groups of the plurality of collaboration contacts have different group availability statuses, an amount of the plurality of collaboration contacts in each of the different sub-groups being indicated by the group presence indicator.

20. The system according to claim 19, wherein:
the group presence indicator includes a graphical representation; and
when the different sub-groups of the plurality of collaboration contacts have the different group availability statuses, the graphical representation may include a plurality of sections, each one section of the plurality of sections having a different presentation type corresponding to a different one of the different group availability statuses, an angular dimension of each one section of the plurality of sections corresponding to the amount of the plurality of collaboration contacts in one of the different sub-groups indicated by the one section.
